(19) United States
(12) Patent Application Publication
(10) Pub. No.: US 2018/0174230 A1
(43) Pub. Date: Jun. 21, 2018

(54) EVALUATING ONLINE SYSTEM USER INTERACTION WITH DIFFERENT CONTENT ITEMS WHILE MAINTAINING BUDGET ALLOCATIONS FOR PRESENTING EACH DIFFERENT CONTENT ITEM

(71) Applicant: Facebook, Inc., Menlo Park, CA (US)

(72) Inventors: Harsh Doshi, San Francisco, CA (US); Xin Liu, Fremont, CA (US); Chandrashekhar Nagarajan, Cupertino, CA (US); Anand Sumatilal Bhalgat, Mountain View, CA (US); Wenjie Fu, Foster City, CA (US); Subha Ramakrishna Gummadi, Palo Alto, CA (US); Dianshi Li, Sunnyvale, CA (US)

(21) Appl. No.: 15/383,919

(22) Filed: Dec. 19, 2016

(51) Int. Cl. G06Q 40/02; G06Q 30/06

(52) U.S. Cl. CPC G06Q 40/02; G06Q 50/00; G06Q 30/0601

(57) ABSTRACT

An online system presents different content items to different sets of users to evaluate how changes to content or changes to the online system affect user interaction with the content items or presentation of the content items. However, if the online system receives compensation for presenting different content items, the online system may receive a disproportionate amount of compensation for presenting one of the content items that improves user interaction. To prevent such disproportionate allocation of compensation between presentation of different contents items, the online system allocates sets of users to whom different content items are eligible to be presented to maintain a specified budget for presenting the different content items. The online system also differently allocates users across sets to whom different content items are eligible for presentation to prevent biasing of users from presentation of other different content items to users done in parallel.

### BACKGROUND

This disclosure relates generally to presenting content to users of an online system, and more specifically to evaluating presentation of content items to users of the online system.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

Often, a publishing user may seek to evaluate effectiveness of presenting different content items to users of an online system in influencing actions by online system users or in gaining attention of online system users. To evaluate different content items, a publishing user may provide the online system with a content item and an alternative content item along with instructions to withhold presentation of the content item or the alternative content item to a specified amount of users. This causes the online system to present the alternative content item, rather than the content item to certain users.

However, many publishing users specify a budget for presenting a content item to online system users, with the budget specifying a maximum amount of compensation a publishing user provides the online system in exchange for presenting the content item or in exchange for certain actions by online system users after being presented with the content item. When evaluating an alternative content item for presentation, a budget specified by a publishing user encompasses presentation of the content item and the alternative content item. If an online system accounts for likelihoods of user interactions with content items when selecting content items, if the content item or the alternative content item has a higher likelihood of causing or receiving user interactions, the online system may disproportionately select one or the content item or the alternative content item for presentation, so a disproportionate amount of the specified budget is used for presenting the content item or the alternative content item. This increased presentation of the content item or of the additional content item may bias the evaluation towards whichever of the content item or the additional content item was more frequently presented, providing the publishing user with inaccurate evaluation of effectiveness of the content item or the alternative content item.

### SUMMARY

An online system presents various content items to its users. In various embodiments, the online system obtains content items from a user and includes the content items in one or more selection processes selecting content for presentation to other online system users. A user providing content items to the online system may provide a content item and an alternative content item for presentation by the online system to evaluate effectiveness of the content item and the alternative content item in inciting user interactions or actions. In various embodiments, the alternative content item is a modified version of the content item. For example, the content item and alternative content item include common text data, but include different images. As another example, the alternative content item and the content item include the same components, but the alternative content item differently positions or formats the components than the content item. The user also specifies a budget for presenting the content item and the alternative content item to the online system.

To allow the user to more accurately evaluate effectiveness of the content item and the alternative content item in inciting user actions, the online system obtains a portion of the budget for presenting the content item and an additional portion of the budget for presenting the alternative content item. The user may specify the portion of the budget and the additional portion of the budget, or the online system may determine the portion of the budget and the additional portion of the budget based on information received from the user. In some embodiments, the user providing the content item and the alternative content item to the online system specifies a percentage of the budget for presenting the content item and specifies another percentage of the budget for presenting the alternative content item. Alternatively, the user specifies a percentage of users eligible to be presented with the content item or the alternative content item to whom the content item or the alternative content item is withheld from presentation, and the online system determines the portion of the budget and the additional portion of the budget based on a number of users eligible to be presented with the content item or the alternative content item and the specified percentage.

The online system determines a set of users to whom the content item is eligible for presentation and to whom the alternative content item is withheld. Similarly, the online system determines an alternative set of users to whom the content item is withheld from presentation and to whom the alternative content item is eligible for presentation. In various embodiments, the online system determines the set and the alternative set so users of the set and users of the alternative set have at least a threshold amount of common characteristics. Additionally, the online system may determine the set and the alternative set so the set and the alternative set include an equal number of users, or have less than a threshold difference between a number of users in the set and a number of users in the alternative set. When an opportunity to present content to a user of the set is identified, the online system includes the content item, but not the alternative content item, in one or more selection processes selecting content for presentation to the user. Similarly, when an opportunity to present content to a user of the alternative set is identified, the online system includes the alternative content item, but not the content item, in one or more selection processes selecting content for presentation to the user.

To prevent disproportionate presentation of the content item or the alternative content item, as the content item and the alternative content item are presented to online system users, the online system determines an amount received for presenting the content item and an additional amount received for presenting the alternative content item. When the amount received for presenting the content item equals the portion of the budget for presenting the content item, the online system withholds the content item from inclusion in selection processes. Similarly, when the additional amount received for presenting the alternative content item equals the additional portion of the budget for presenting the alternative content item, the online system withholds the alternative content item from inclusion in selection processes. Hence, the online system maintains allocations of a budget between presenting the content item and the alternative content item to prevent bias towards presenting one of the content item or the additional content item having a higher likelihood of receiving user interactions or of encouraging user action.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment of.

FIG. 3 is a flowchart of a method for evaluating presentation of different content to users of an online system subject to allocations of a budget for content item presentation between the different content items, in accordance with an embodiment.

FIGS. 4A and 4B are conceptual diagrams showing presentation of a content item and an alternative content to users of an online system subject to allocation of a budget between presenting the content item and the alternative content item, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

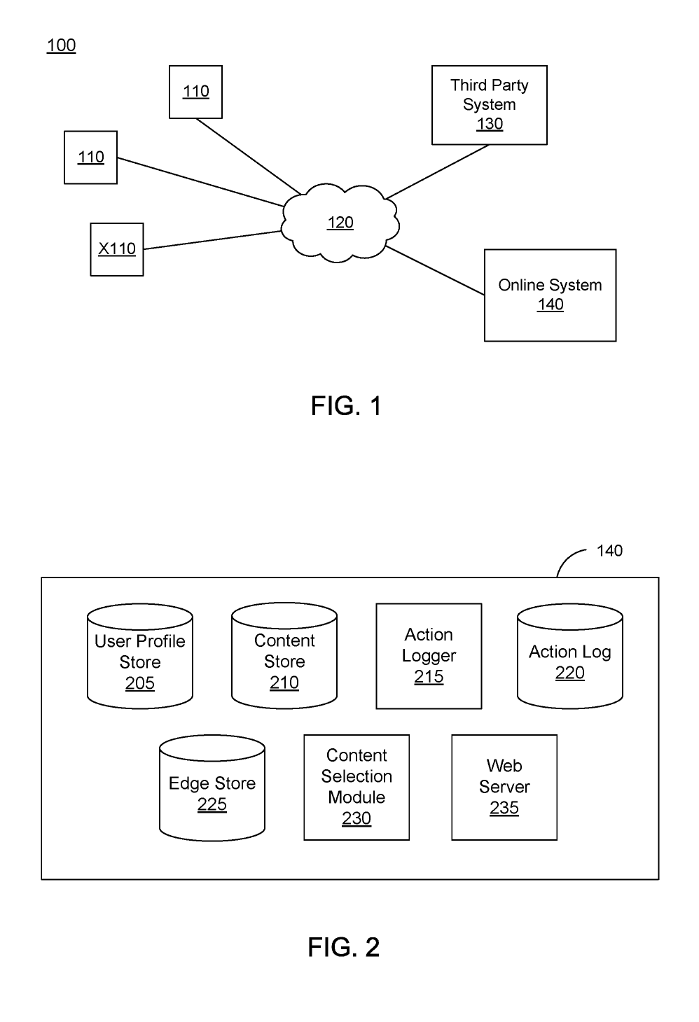

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store 210 for subsequent retrieval by the content selection module 230, which is further described below.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

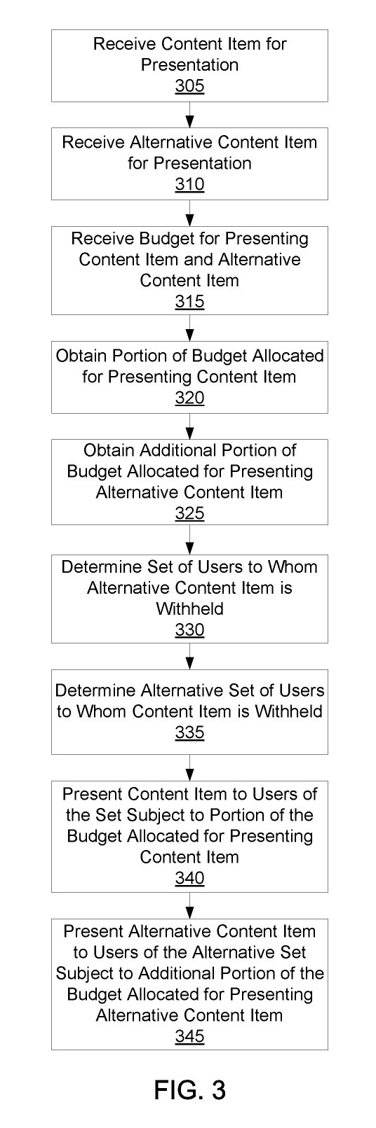

As further described below in conjunction with FIG. 3, the content selection module 230 allows a user providing a content item and an alternative content item to evaluate effectiveness of the content item and the alternative content item in receiving user interaction or in inciting user actions. To more accurately evaluate the content item and the alternative content item, the content selection module 230 obtains a budget for presenting the content item and the alternative content item from the user and obtains a portion of the budget for presenting the content item and an additional portion of the budget for presenting the alternative content item. The user may specify the portion of the budget and the additional portion of the budget, or the online system 140 may determine the portion of the budget and the additional portion of the budget based on information received from the user.

The content selection module 230 determines a set of users to whom the content item is eligible for presentation and to whom the alternative content item is withheld. Similarly, the content selection module determines an alternative set of users to whom the content item is withheld from presentation and to whom the alternative content item is eligible for presentation. In various embodiments, the content selection module 230 determines the set and the alternative set so users of the set and users of the alternative set have at least a threshold amount of common characteristics. Additionally, the content selection module 230 may determine the set and the alternative set so the set and the alternative set include an equal number of users, or have less than a threshold difference between a number of users in the set and a number of users in the alternative set. When an opportunity to present content to a user of the set is identified, the content selection module 230 includes the content item, but not the alternative content item, in one or more selection processes selecting content for presentation to the user. Similarly, when an opportunity to present content to a user of the alternative set is identified, the content selection module 230 includes the alternative content item, but not the content item, in one or more selection processes selecting content for presentation to the user.

To prevent disproportionate presentation of the content item or the alternative content item, as the content item and the alternative content item are presented to online system users, the content selection module 230 determines an amount received for presenting the content item and an additional amount received for presenting the alternative content item. When the amount received for presenting the content item equals the portion of the budget for presenting the content item, the content selection module 230 withholds the content item from inclusion in selection processes. Similarly, when the additional amount received for presenting the alternative content item equals the additional portion of the budget for presenting the alternative content item, the content selection module 230 withholds the alternative content item from inclusion in selection processes. Hence, the content selection module 230 maintains allocations of a budget between presenting the content item and the alternative content item to prevent bias towards presenting one of the content item or the additional content item having a higher likelihood of receiving user interactions or of encouraging user action, as further described below in conjunction with FIG. 3.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

### Presenting Different Content Items to Different Users Subject to Budget Allocations for the Different Content Items

FIG. 3 is a flowchart of one embodiment of a method for evaluating presentation of different content to users of an online system 140 subject to allocations of a budget for content item presentation between the different content items. In other embodiments, the method may include different and/or additional steps than those shown in FIG. 3. Additionally, steps of the method may be performed in different orders than the order described in conjunction with FIG. 3 in various embodiments.

The online system 140 receives 305 a content item for presentation to users of the online system 140. As further described above in conjunction with FIG. 2, the content item is associated with a bid amount specifying an amount of compensation the online system 140 receives from a user for presenting the content item to users or for users performing one or more actions after being presented with the content item. The online system 140 also receives 310 an alternative content item for presentation to users of the online system 140, with the alternative content item associated with an additional bid amount specifying an additional amount of compensation the online system 140 receives for presenting the alternative content item to users or for users performing one or more actions after being presented with the alternative content item. For example, the online system 140 receives a group of content items, with the group including the content item and including the alternative content item.

In various embodiments, the alternative content item is a modified version of the content item. For example, the alternative content item has a subset of components matching components of the content item and one or more alternative components differing from corresponding components of the content item. As an example, the content item and the alternative content item each include a common image, but text included in the content item differs from text included in the alternative content item. In another example, the content item and the alternative content item include common text, but an image included in the content item differs from an alternative image included in the alternative content item. For an additional example, the content item and the alternative content item each include common text and image data, but a landing page included in the content item differs from an alternative landing page included in the alternative content item. Additionally, in various embodiments, the bid amount associated with the content item differs from the additional bid amount associated with the alternative content item. Alternatively, the bid amount equals the additional bid amount.

Additionally, the online system 140 receives 315 a budget for presenting the content item and the alternative content item to users. The budget specifies a total amount allocated for presentation of the content item and the alternative content item to online system users. As described above, the online system 140 accounts for likelihoods of a user interacting with various content items when selecting content items for presentation to the user. Hence, if users are more likely to interact with the content item than with the alternative content item, the content item is more frequently presented by the online system 140 to users than the alternative content item, causing a disproportionate amount of the budget to be used for presenting the content item than for presenting the alternative content item. This reduction in presentation of the alternative content item limits evaluation of interaction with the alternative content item. Similarly, if users are more likely to interact with the alternative content item than with the content item, the online system 140 uses a disproportionate amount of the budget for presentation of the alternative content item, reducing presentation of the content item to users and limiting evaluation of the content item.

To more accurately evaluate interactions by online system users after presentation of the content item and presentation of the alternative content item, the online system 140 obtains 320 a portion of the budget allocated for presenting the content item to users of the online system 140 and obtains 325 an additional portion of the budget allocated for presenting the alternative content item to users of the online system 140. In some embodiments, a user from whom the online system 140 received 305 the content item and received 310 the alternative content item specifies a monetary amount for the portion of the budget and another monetary amount for the additional portion of the budget, allowing the user from whom the online system 140 received 305 the content item and received 310 the alternative content item to specify a monetary amount allocated for presenting the content item and the additional content item. Alternatively, the user from whom the online system 140 received 305 the content item and received 310 the alternative content item specifies a percentage of the budget as the portion for presenting the content item and specifies an additional percentage of the budget as the additional portion for presenting the additional content item. The online system 140 determines the percentage of the budget as the portion of the budget and determines the additional percentage of the budget as the additional portion of the budget.

In other embodiments, the online system 140 obtains 320 the portion of the budget allocated for presenting the content item by determining a number of users eligible to be presented with the content item or eligible to be presented with the alternative content item and determines an amount of the determined number of users to whom the alternative content item is not eligible for presentation. For example, the online system 140 determines a number of users having characteristics satisfying at least a threshold amount of targeting criteria included in the content item or satisfying at least the threshold amount of targeting criteria included in the alternative content item. The online system 140 subsequently determines an amount of the number of users eligible to be presented with the content item or with the alternative content item to whom the alternative content item is withheld from presentation. For example, the online system 140 receives the amount of users eligible to be presented with the content item or with the alternative content item to whom the alternative content item is withheld from a user providing the content item and the alternative content item to the online system 140. As an example, the online system 140 receives a percentage of users eligible to be presented with the content item or with the alternative content item to whom the alternative content item is withheld, and determines the amount as the received percentage of the users eligible to be presented with the content item. The online system 140 obtains 320 the portion of the budget allocated for presentation of the content item as a product of the budget and a ratio of the amount of users to whom the alternative content is withheld to the number of users eligible to be presented with the content item or with the alternative content item. To obtain 325 the additional portion of the budget allocated for presentation of the alternative content item, the online system 140 determines a difference between the budget and the portion of the budget.

In other embodiments, the online system 140 determines the of users eligible to be presented with the content item or with the alternative content item and determines an amount of users to whom the content item is withheld from presentation. The online system 140 determines a ratio of the number of users eligible to be presented with the content item or with the alternative content item and determines the additional portion of the budget allocated for presentation of the alternative content item as a product of the budged and the determined ratio. Similar to described above, the online system 140 determines the portion of the budget allocated for presentation of the content item as a difference between the budget and the additional portion. Hence, the online system obtains 320 a portion of the budget used for presenting the content item and also obtains 325 an additional portion of the budget used for presenting the alternative content item, allowing the budget to be allocated between presentation of the content item and presentation of the alternative content item to various users of the online system. As further described above, a user providing the content item and the alternative content item to the online system 140 may allocate the budget by specifying different monetary amounts used for presenting the content item and for presenting the alternative content item or by specifying different amounts of users eligible to be presented with the content item or with the alternative content item to whom the content item or the alternative content item is withheld from presentation. This allows the user providing the content item and the alternative content item to regulate presentation of the content item or the alternative content item to different online system users.

When selecting content for presentation to various users, the online system 140 determines 330 a set of users to whom the content item is eligible for presentation and to whom the alternative content item is withheld from presentation and determines 335 an alternative set of users to whom the content item is withheld from presentation and the alternative content item is eligible for presentation. The online system 140 may determine 330 the set and determine 335 the alternative set based on received information identifying a percentage of users eligible to be presented with the content item to whom the content item is withheld. In various embodiments, the online system 140 receives the information from a user providing the content item and the alternative content item to the online system 140. This allows the user providing the content item and the alternative content item to specify a percentage or other amount of users to whom the alternative content item, rather than the content item, is eligible for presentation. To determine 330 the set of users to whom the content item is eligible for presentation and to whom the alternative content item is withheld from presentation, the online system 140 may sample users eligible to be presented with the content item or with the alternative content item to determine 335 the additional set of users to whom the content item is withheld for presentation and to whom the alternative content item is eligible for presentation and determine 330 the set of users as users eligible to be presented with the content item or with the alternative content item who are not included in the additional set. In various embodiments, the online system 140 determines 330 the set and determines 335 the additional set so an equal number of users are in the set and in the additional set. Additionally, in various embodiments, the online system 140 determines 330 the set and determines 335 the alternative set so users of the set have at least a threshold amount of characteristics matching characteristics of users of the alternative set.

For a user of the set, when the online system 140 identifies an opportunity to present content, the online system 140 includes the content item in one or more selection processes selecting the content for presentation to the user. Similarly, for a user of the alternative set, when the online system 140 identifies an opportunity to present content, the online system 140 includes the alternative content item in one or more selection processes. As further described above in conjunction with FIG. 2, the online system 140 receives compensation from a user who provided the content item and the alternative content item to the online system 140 in exchange for presenting the content item or the alternative content item to users or for users presented with the content item or with the alternative content item performing one or more actions after being presented with the content item or with the alternative content item. To prevent one of the content item or the alternative content item being disproportionately presented to online system users, the online system 140 presents 340 the content item to users of the set so an amount of compensation the online system 140 received for presenting the content item does not exceed the portion of the budget. Similarly, the online system 140 presents 345 the alternative content item to users of the alternative set so an amount of compensation the online system 140 receives for presenting the alternative content item does not exceed the additional portion of the budget.

In various embodiments, when the online system 140 receives compensation from the user who provided the content item and the alternative content item to the online system 140, the user identifies whether the compensation is for presentation of the content item or the alternative content item. Based on the identifications from the user, the online system 140 determines an amount of compensation received for presenting the content item and an additional amount of compensation received for presenting the alternative content item. The online system 140 includes the content item in one or more selection processes selecting content for presentation to users of the set, while withholding the alternative content item from the one or more selection processes selecting content for presentation to users of the set until the amount of compensation received by the online system 140 for presenting the content item equals the portion of the budget. In some embodiments, the online system 140 withholds the content item from inclusion in selection processes selecting content for users of the set when the amount of compensation received by the online system 140 for presenting the content item equals the portion of the budget. Similarly, the online system 140 includes the alternative content item in one or more selection processes selecting content for presentation to users of the alternative set, while withholding the content item from the one or more selection processes selecting content for presentation to users of the alternative set until the amount of compensation received by the online system 140 for presenting the alternative content item equals the additional portion of the budget. In some embodiments, the online system 140 withholds the alternative content item from inclusion in selection processes selecting content for users of the alternative set when the amount of compensation received by the online system 140 for presenting the alternative content item equals the additional portion of the budget.

Hence, the online system 140 limits presentation of the content item and the alternative content item to users based on the portion of the budget allocated to presentation of the content item and the additional portion of the budget allocated to presentation the alternative content item. This prevents the online system 140 from disproportionately presenting the content item or the alternative content item if the content item or the alternative content item has a higher likelihood of receiving or causing user interaction, allowing the user providing the content item and the alternative content item to more accurately evaluate relative effectiveness of the content item and the alternative content item in encouraging actions by online system users. Additionally, if the online system 140 is evaluating multiple content items and alternative content items, for each pairing of content item and alternative content item, the online system 140 determines whether a user is in a group to whom the content item is withheld from presentation or to whom the alternative content item is withheld from presentation independently of determinations of whether the user is included in groups to whom other content items are withheld from presentation. For example, if the online system 140 receives an additional content item to evaluate relative to the content item, the online system 140 determines whether the additional content item is withheld from presentation to a user independently of a determination of whether the alternative content item was withheld from presentation to the user. By independently determining whether different content items are withheld from a user, the online system 140 prevents certain users from consistently being ineligible to be presented with certain content items, further reducing bias by increasing likelihoods of the different content items being presented to variety of users.

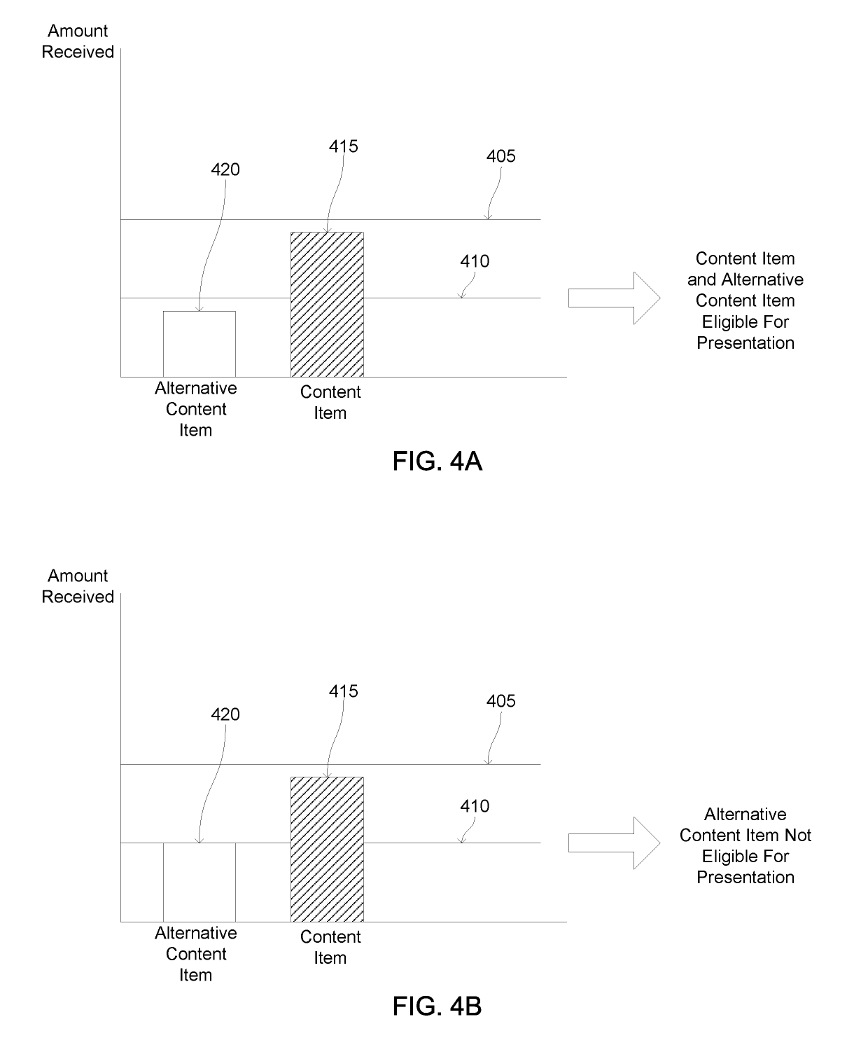

FIGS. 4A and 4B are conceptual diagrams showing presentation of a content item and an alternative content to users of an online system 140 subject to allocation of a budget between presenting the content item and the alternative content item. In the example of FIG. 4A, the online system 140 received a budget for presentation of the content item and the alternative content item and obtained a portion 405 of the budget for presenting the content item and an additional portion 410 of the budget for presenting the alternative content item, as further described above in conjunction with FIG. 3. As the online system 140 presents the content item and the alternative content items to various users, as further described above in conjunction with FIG. 3, the online system 140 determines an amount of revenue 415 received by the online system 140 for presenting the content item and an additional amount of revenue 420 received by the online system 140 for presenting the alternative content item. In the example of FIG. 4A, the amount of revenue 415 received by the online system 140 for presenting the content item is less than the portion 405 of the budget allocated for presentation of the content item, and the amount of revenue 420 received by the online system 140 for presenting the alternative content item is less than the additional portion 410 of the budget allocated for presenting the alternative content item. Hence, the online system 140 includes the content item and the alternative content item in one or more selection processes selecting content for presentation to various users, as further described in conjunction with FIG. 3.

In the example shown by FIG. 4B, the amount of revenue 415 received by the online system 140 for presenting the content item is less than the portion 405 of the budget allocated for presentation of the content item, while the amount of revenue 420 received by the online system 140 for presenting the alternative content item equals the additional portion 410 of the budget allocated for presenting the alternative content item. For example, the online system 140 determines the alternative content item has a higher likelihood of causing user actions, so one or more selection processes applied by the online system 140 and including the alternative content item more frequently select the alternative content item for presentation than selection processes including the content item select the content item for presentation. As further described above in conjunction with FIG. 4, to prevent disproportionate presentation of the content item, which may cause the alternative content item to appear more effective in causing user actions from the increased presentation, the online system 140 withholds inclusion of the alternative content item in selection processes when the amount of revenue 420 received by the online system 140 from presenting the alternative content item equals the additional portion 420 of the budget allocated for presentation of the alternative content item.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a content item at an online system, the content item associated with an amount of compensation provided to the online system for presenting the content item;
receiving an alternative content item at the online system, the alternative content item associated with an additional amount of compensation provided to the online system for presenting the alternative content item;
receiving a budget for presenting the content item and the alternative content item to users of the online system;
obtaining a portion of the budget allocated for presenting the content item to users of the online system;
obtaining an additional portion of the budget allocated for presenting the alternative content item to users of the online system;
determining a set of users of the online system to whom the content item is eligible for presentation and to whom the alternative content item is withheld from presentation;
determining an alternative set of users of the online system to whom the alternative content item is eligible for presentation and to whom the content item is withheld from presentation;
presenting the content item to users of the set so an amount of compensation received by the online system for presenting the content item does not exceed the portion of the budget; and
presenting the alternative content item to users of the alternative set so an amount of compensation received by the online system for presenting the alternative content item does not exceed the additional portion of the budget.

2. The method of claim 1, wherein obtaining the portion of the budget allocated for presenting the content item to users of the online system comprises:
determining a number of users eligible to be presented with the content item or with the alternative content item;
determining an amount of the determined number of users to whom the alternative content item is not eligible for presentation;
determining the portion of the budget allocated for presenting the content item to users of the online system based on the determined amount and the determined number of users.

3. The method of claim 2, wherein determining the amount of the determined number of users to whom the content item is not eligible for presentation comprises:
receiving a percentage of the determined number of users to whom the alternative content item is not eligible for presentation from a user associated with the content item.

4. The method of claim 2, wherein determining the portion of the budget allocated for presenting the content item to users of the online system based on the determined amount and the determined number of users comprises:
determining a ratio of the determined amount and the determined number; and
determining the portion of the budget allocated for presenting the content item to users of the online system as a product of the ratio and the budget.

5. The method of claim 4, wherein obtaining the additional portion of the budget allocated for presenting the alternative content item to users of the online system comprises:
determining the additional portion as a difference between the budget and the portion of the budget.

6. The method of claim 1, wherein the alternative content item comprises a modified version of the content item.

7. The method of claim 1, wherein presenting the content item to users of the set so the amount of compensation received by the online system for presenting the content item does not exceed the portion of the budget comprises:
including the content item in one or more selection processes selecting content for presentation to a user of the set and withholding the alternative content item from the one or more selection processes until the amount of compensation received by the online system for presenting the content item equals the portion of the budget.

8. The method of claim 1, wherein presenting the alternative content item to users of the alternative set so the amount of compensation received by the online system for presenting the alternative content item does not exceed the additional portion of the budget comprises:
including the alternative content item in one or more selection processes selecting content for presentation to a user of the alternative set and withholding the content item from the one or more selection processes until the amount of compensation received by the online system for presenting the alternative content item equals the additional portion of the budget.

9. The method of claim 1, wherein users of the set have at least a threshold amount of characteristics matching characteristics of users of the alternative set.

10. The method of claim 1, further comprising:
receiving an additional content item; and
determining whether to include a user in another set of users to whom the additional content item is eligible for presentation independent of whether the user is included in the set or in the additional set.

11. A computer program product comprising a computer readable storage medium having instructions encoded thereon that, when executed by a processor, cause the processor to:
receive a content item at an online system, the content item associated with an amount of compensation provided to the online system for presenting the content item;
receive an alternative content item at the online system, the alternative content item associated with an additional amount of compensation provided to the online system for presenting the alternative content item;
receive a budget for presenting the content item and the alternative content item to users of the online system;
obtain a portion of the budget allocated for presenting the content item to users of the online system;
obtain an additional portion of the budget allocated for presenting the alternative content item to users of the online system;
determine a set of users of the online system to whom the content item is eligible for presentation and to whom the alternative content item is withheld from presentation;
determine an alternative set of users of the online system to whom the alternative content item is eligible for presentation and to whom the content item is withheld from presentation;
present the content item to users of the set so an amount of compensation received by the online system for presenting the content item does not exceed the portion of the budget; and
present the alternative content item to users of the alternative set so an amount of compensation received by the online system for presenting the alternative content item does not exceed the additional portion of the budget.

12. The computer program product of claim 11, wherein obtain the portion of the budget allocated for presenting the content item to users of the online system comprises:
determine a number of users eligible to be presented with the content item or with the alternative content item;
determine an amount of the determined number of users to whom the alternative content item is not eligible for presentation;
determine the portion of the budget allocated for presenting the content item to users of the online system based on the determined amount and the determined number of users.

13. The computer program product of claim 12, wherein determine the amount of the determined number of users to whom the content item is not eligible for presentation comprises:
receive a percentage of the determined number of users to whom the alternative content item is not eligible for presentation from a user associated with the content item.

14. The computer program product of claim 12, wherein determining the portion of the budget allocated for presenting the content item to users of the online system based on the determined amount and the determined number of users comprises:
determine a ratio of the determined amount and the determined number; and
determine the portion of the budget allocated for presenting the content item to users of the online system as a product of the ratio and the budget.

15. The computer program product of claim 14, wherein obtain the additional portion of the budget allocated for presenting the alternative content item to users of the online system comprises:
determining the additional portion as a difference between the budget and the portion of the budget.

16. The computer program product of claim 11, wherein the alternative content item comprises a modified version of the content item.

17. The computer program product of claim 11, wherein present the content item to users of the set so the amount of compensation received by the online system for presenting the content item does not exceed the portion of the budget comprises:
include the content item in one or more selection processes selecting content for presentation to a user of the set and withholding the alternative content item from the one or more selection processes until the amount of compensation received by the online system for presenting the content item equals the portion of the budget.

18. The computer program product of claim 11, wherein present the alternative content item to users of the alternative set so the amount of compensation received by the online system for presenting the alternative content item does not exceed the additional portion of the budget comprises:
include the alternative content item in one or more selection processes selecting content for presentation to a user of the alternative set and withholding the content item from the one or more selection processes until the amount of compensation received by the online system for presenting the alternative content item equals the additional portion of the budget.

19. The computer program product of claim 11, wherein users of the set have at least a threshold amount of characteristics matching characteristics of users of the alternative set.

20. The computer program product of claim 11, wherein the computer readable storage medium further has instructions encoded thereon that, when executed by the processor, cause the processor to:
receive an additional content item; and
determine whether to include a user in another set of users to whom the additional content item is eligible for presentation independent of whether the user is included in the set or in the additional set.
